(19) United States
(12) Patent Application Publication
(10) Pub. No.: US 2013/0034670 A1
(43) Pub. Date: Feb. 7, 2013

(54) DISPLAY COVER GLASS AND DISPLAY

(71) Applicants: Kazuaki Hashimoto, Shinjuku-ku (JP); Youichi Hachitani, Shinjuku-ku (JP); Kinobu Osakabe, Shinjuku-ku (JP)

(72) Inventors: Kazuaki Hashimoto, Shinjuku-ku (JP); Youichi Hachitani, Shinjuku-ku (JP); Kinobu Osakabe, Shinjuku-ku (JP)

(73) Assignee: HOYA CORPORATION, Shinjuku-ku, Tokyo (JP)

(21) Appl. No.: 13/636,275

(22) PCT Filed: Mar. 18, 2011
(86) PCT No.: PCT/JP2011/056556

§ 371 Date: Oct. 16, 2012

(30) Foreign Application Priority Data
Mar. 24, 2010 (JP) 2010-068655

(51) Int. Cl. C03C 3/095; B32B 17/00

(52) U.S. Cl. 428/1.32; 428/220; 428/337

(57) ABSTRACT

Disclosed are a thin-sheet cover glass that is high in quality and has high mechanical strength, and a display equipped with the aforementioned cover glass. The cover glass is used to cover the image display unit of a display and to make images displayed by the aforementioned image display unit opaque. The cover glass is formed from a glass that comprises, in an oxide base conversion indicated in mol %, 60 to 75% SiO₂, 0 to 12% Al₂O₃ (provided that the total content of SiO₂ and Al₂O₃ is 68% or more), 0 to 10% B₂O₃, 5 to 26% Li₂O and Na₂O in total, 0 to 8% K₂O (provided that the total content of Li₂O, Na₂O, and K₂O is 26% or less), 0 to 18% MgO, CaO, SrO, BaO in total, and ZnO, and 0 to 5% ZrO₂, TiO₂, and HfO₂ in total, as well as a total of 0.1 to 3.5 mass % of an Sn oxide and a Ce oxide relative to the total mass, wherein (Sn oxide content/(Sn oxide content+Ce oxide content)) is 0.01 to 0.99, and the content of an Sb oxide is 0 to 0.1%; and has a plate thickness of no more than 1.0 mm.

### CROSS-REFERENCE TO RELATED APPLICATIONS

This application claims benefit of priority to Japanese Patent Application No. 2010-68655 filed on Mar. 24, 2010, which is expressly incorporated herein by reference in its entirety.

### TECHNICAL FIELD

The present invention relates to a cover glass for use on a display, and to a display equipped with this cover glass.

### BACKGROUND ART

In portable terminal devices such as portable telephones and personal digital assistants (PDAs), as well as other portable equipment, a protective layer is provided to prevent the exertion of shock and external forces on a display (for example, Patent Reference 1). In recent years, with the reduction in thickness of portable terminal devices and portable equipment, the use of a protective plate employing chemically reinforced glass that is strong while being thin and inhibiting deflection has been proposed (for example, Patent Reference 2).

### PRIOR ART REFERENCES

### Patent References

Patent Reference 1: Japanese Unexamined Patent Publication (KOKAI) No. 2004-299199

Patent Reference 2: Japanese Unexamined Patent Publication (KOKAI) No. 2007-099557

The entireties of the Patent References 1 and 2 are hereby incorporated herein by reference.

When glass is employed as the above protective plate, it is referred to as a cover glass. Although such cover glasses have been growing thinner, it is thought that an ultrathin plate of 1.0 mm or less will be required in the future.

As the thickness of the cover glass has been reduced to 1.0 mm and below, problems that were not previously apparent have emerged.

When air bubbles produced during glass manufacturing remain in a thin plate of glass, even when quite minute, they greatly compromise mechanical strength. Conventionally, the method of maintaining mechanical strength by chemically reinforcing the glass has been adopted. However, when residual bubbles are contained in extremely thin plates of glass, the effective thickness of portions in which bubbles are present ends up being further reduced.

Further, when glass containing residual bubbles is chemically strengthened, there are problems in that the in-plane distribution of stress becomes nonuniform around the bubbles, localized strain occurs, and the quality of the display image that is seen through the cover glass diminishes.

The present invention, devised to solve the above problems that have resulted from the reduction in thickness of cover glasses, has for its object to provide a thin, high-quality cover glass of high mechanical strength, and a display equipped with this cover glass.

### Means of Solving the Problem

The present inventors discovered that an extremely good clarifying effect was achieved due to a synergistic effect based on two oxides when an Sn oxide and a Cn oxide were both added to a glass having a prescribed composition range suited to cover glasses, and that by reducing the residual bubbles in the glass to an extremely low level, adequate mechanical strength could be maintained while reducing the thickness of the cover glass to 1.0 mm or less. The present invention was devised on that basis.

That is, the present invention provides, as means of solving the above-stated problems:
(1) a cover glass for use in transmitting the image displayed by an image display member while covering the image display member of a display, characterized:

by being comprised of a glass comprising, converted based on the oxide and denoted as mol %:

60 to 75% of SiO₂;

0 to 12% of Al₂O₃

(where the combined content of SiO₂ and Al₂O₃ is 68% or greater);

0 to 10% of B₂O₃;

5 to 26% of Li₂O and Na₂O in total;

0 to 8% of K₂O

(where the combined content of Li₂O, Na₂O, and K₂O is 26% or less);

0 to 18% of MgO, CaO, SrO, BaO, and ZnO in total;

0 to 5% of ZrO₂, TiO₂, and HfO₂ in total;

0.1 to 3.5 weight percent of Sn oxides and Ce oxides based on the total amount of the glass components; and

a ratio of the content of Sn oxides to the combined content of Sn oxides and Ce oxides (content of Sn oxides/(content of Sn oxides+content of Ce oxides)) of 0.01 to 0.99;

the content of Sb oxides is 0.1% or less; and

by having a thickness of 1.0 mm or less;
(2) the cover glass according to (1), wherein the cover glass has a compressive stress layer on the outer surface thereof;
(3) the cover glass according to (2), wherein the compressive stress layer is formed by chemical reinforcement;
(4) the cover glass according to any one of (1) to (3), the outer surface of which is equipped with a shatter-proof film; and
(5) a display, equipped with the cover glass according to any one of (1) to (4) and wherein the cover glass is mounted so as to cover the display screen.

### Effect of the Invention

The present invention provides a cover glass of high mechanical strength and a thickness of 1.0 mm or less, and a display equipped with this cover glass.

### BRIEF DESCRIPTION OF DRAWINGS

FIG. 1 A sectional view showing a partial schematic of a portable information terminal on which the cover glass of the present invention is mounted.

### MODES OF CARRYING OUT THE INVENTION

The present invention is a cover glass, transmitting the image displayed by an image display member while covering the image display member of a display, characterized:

by being comprised of a glass comprising, converted based on the oxide and denoted as mole %:

60 to 75% of SiO₂;

0 to 12% of Al₂O₃

(where the combined content of SiO₂ and Al₂O₃ is 68% or greater);

0 to 10% of B₂O₃;

5 to 26% of L1₂O and Na₂O in total;

0 to 8% of K₂O

(where the combined content of Li₂O, Na₂O, and K₂O is 26% or less);

0 to 18% of MgO, CaO, SrO, BaO, and ZnO in total;

0 to 5% of ZrO₂, TiO₂, and HfO₂ in total;

0.1 to 3.5 weight percent of Sn oxides and Ce oxides based on the total amount of the glass components; and

a ratio of the content of Sn oxides to the combined content of Sn oxides and Ce oxides (content of Sn oxides/(content of Sn oxides+content of Ce oxides)) of 0.01 to 0.99;

the content of Sb oxides is 0.1% or less; and

by having a thickness of 1.0 mm or less.

The glass constituting the cover glass of the present invention is referred to as glass A hereinafter.

When glass is molten, Sn primarily functions strongly to promote clarification by positively releasing oxygen gas at a temperature range of about 1,400 to 1,600° C., while Ce functions strongly to pick up oxygen gas in the glass melt and fix it as a glass component at a temperature range of about 1,200 to 1,400° C. By having both Sn and Ce present in the glass and causing the oxygen gas releasing effect of Sn and the oxygen gas pickup effect of Ce to work in concert, it is possible to achieve an excellent clarifying effect and prevent a decrease in the mechanical strength of a cover glass the thickness of which has been reduced.

To achieve an effect due to the combined presence of Sn and Ce requires a process of maintaining a temperature exceeding 1,400° C. when the glass is molten and then maintaining a temperature lower than 1,400° C. Further, the viscosity of the glass at 1,400° C., where the temperature range of the clarifying effect of Sn meets the temperature range of the clarifying effect of Ce, greatly affects clarifying efficiency. When the viscosity at 1,400° C. is high, migration of the bubbles in the glass melt tends to be impeded, tending to decrease clarifying efficiency. Accordingly, it is desirable to adjust the glass composition so that the viscosity at 1,400° C. is 5×10³ dP·s or less, preferably 1×10³ dPa·s or less. From that perspective, the composition of glass A is suitable.

Glass A is amorphous glass, having much better visible light-transmitting properties and workability than crystallized glass. It also has good chemical durability and is suited to chemical reinforcement.

The composition of glass A will be described below. Unless specifically stated otherwise, the contents of Sn oxides, Ce oxides, and Sb oxides are denoted as the weight percentages of the quantities added based on the total amount of the glass components (the quantity added being the weight ratio relative to 100 weight percent, with this 100 weight percent being the combined contents of glass components other than the Sn oxides, Ce oxides, and the Sn oxides described further below). The contents and combined contents of other components are denoted as mol %.

SiO₂, a glass network-forming component, is an essential component that functions to enhance the glass stability, chemical durability, and in particular, acid resistance. When the content of SiO₂ is less than 60%, this function is not adequately performed, and at greater than 75%, unmelted materials are produced in the glass and the viscosity of the glass during clarification becomes excessive, precluding adequate bubble elimination. In glasses containing unmelted material, the unmelted material becomes a source of light scattering, compromising the image quality of the display. In glasses containing bubbles, the bubbles also become sources of light scattering, compromising the image quality, as well as decreasing the mechanical strength of the glass. Thus, the SiO₂ content is specified as 60 to 75%. The SiO₂ content desirably falls within a range of 60 to 70%, preferably within a range of 62 to 68%, and more preferably, within a range of 63 to 67%.

Al₂O₃ also contributes to glass network formation. It functions to enhance glass stability and chemical durability, as well as increasing the ion-exchanging rate during chemical reinforcement. When the Al₂O₃ content exceeds 12%, glass meltability decreases and unmelted materials tend to be produced. Accordingly, the Al₂O₃ content is specified as 0 to 12%. The Al₂O₃ content desirably falls within a range of 0.5 to 11%, preferably within a range of 4 to 11%. From the perspective of enhancing chemical durability, the combined content of SiO₂ and Al₂O₃ is specified as 68% or greater. The combined content of SiO₂ and Al₂O₃ desirably falls within a range of 70% or greater.

B₂O₃ decreases brittleness and functions to enhance meltability. However, the incorporation of an excessive quantity compromises chemical durability. Thus, the B₂O₃ content is specified as 0 to 10%. When the emphasis is on improving chemical durability, the B₂O₃ content desirably falls within a range of 0 to 5%, preferably within a range of 0 to 2%, and more preferably, 0 to 1%. Still more preferably, none is incorporated at all.

Among alkali metal oxides, Li₂O and Na₂O function to enhance the meltability and moldability of the glass. When preparing a chemically reinforced glass, they are the components that are responsible for the ion exchange during chemical reinforcement. When the combined content of Li₂O and Na₂O is less than 5%, these functions are inadequately performed. In particular, when relatively large quantities of SiO₂ and Al₂O₃ are incorporated to enhance chemical durability, as set forth above, and the combined content of Li₂O and Na₂O is less than 5%, the viscosity of the glass becomes excessive during clarification, precluding an adequate clarifying effect. Additionally, when the combined quantity of Li₂O and Na₂O exceeds 26%, chemical durability and, in particular, acid resistance decrease. Accordingly, the combined quantity of Li₂O and Na₂O is specified as falling within a range of 5 to 26%. The combined quantity of Li₂O and Na₂O desirably falls within a range of 10 to 25%, preferably within a range of 15 to 25%, and more preferably, within a range of 20 to 24%.

K₂O also functions to enhance the meltability and moldability of the glass. However, when the content of K₂O exceeds 8%, chemical durability, and in particular, acid resistance decrease. Accordingly, the K₂O content is specified as 0 to 8%. The K₂O content desirably falls within a range of 0 to 5%, preferably within a range of 0 to 2%.

MgO, CaO, SrO, BaO, and ZnO function to improve the meltability, moldability, and stability of the glass, and greatly raise the coefficient of thermal expansion. However, when incorporated in excessive quantity, they lower the chemical durability of the glass. The combined content of MgO, CaO, SrO, BaO, and ZnO is thus specified as 0 to 18%. The combined content of MgO, CaO, SrO, BaO, and ZnO desirably falls within a range of 0 to 15%. In the course of chemical reinforcement, MgO, CaO, SrO, BaO, and ZnO decrease the ion-exchange rate. Thus, when the emphasis is on achieving efficient chemical reinforcement, the content of these components is desirably kept down. In that case, the combined content of MgO, CaO, SrO, BaO, and ZnO desirably falls within a range of 0 to 7%, preferably within a range of 0 to 5%.

In addition to the above, MgO and CaO function to increase rigidity and hardness. Accordingly, when there is greater emphasis on increasing rigidity and hardness than on efficient chemical reinforcement, the combined content of MgO and CaO desirably falls within a range of 4 to 14%. In that case, the MgO content desirably falls within a range of 2 to 7% and the CaO content within a range of 2 to 9%.

ZrO₂, TiO₂, and HfO₂ function to increase rigidity, fracture toughness, chemical durability, and in particular, resistance to alkalinity. However, when introduced in excessive quantity, meltability decreases. Thus, the combined quantity of ZrO₂, TiO₂, and HfO₂ is specified as 0 to 5%. The combined quantity of ZrO₂, TiO₂, and HfO₂ desirably falls within a range of 1 to 5%, preferably within a range of 1 to 4%.

Among ZrO₂, TiO₂, and HfO₂, ZrO₂ has the greatest chemical durability-enhancing effect and the highest ion exchange efficiency during chemical reinforcement. Thus, the incorporation of ZrO₂ is desirable. The ZrO₂ content desirably falls within a range of 1 to 5%, preferably 1 to 4%. TiO₂ produces deposits on the surface of the glass when the glass is immersed in water, so the TiO₂ content desirably falls within a range of 0 to 2%, preferably within a range of 0 to 1%, and more preferably, none is incorporated at all. HfO₂ is a scarce component. In light of cost, the content thereof is desirably kept to within a range of 0 to 2%, preferably to within a range of 0 to 1%, and more preferably, none is incorporated at all.

P₂O₅ can also be incorporated in trace quantities to the extent that the object of the invention is not lost. However, incorporation in an excessive quantity decreases the chemical durability of the glass. Thus, the content thereof is desirably kept to 0 to 1%, preferably to 0 to 0.5%, more preferably to 0 to 0.3%, and still more preferably, none is incorporated at all.

In glass A, which contains relatively large quantities of SiO₂ and Al₂O₃, the temperature of the glass during clarification is high despite containing alkali metal components. In such a glass, Sb oxides have a poorer clarifying effect than Sn oxides and Ce oxides. In glasses to which Sn oxides are added, the clarifying effect ends up decreasing. When the content of Sb oxides exceeds 0.1%, the residual bubbles in the glass end up rapidly increasing in the presence of Sn oxides. Accordingly, the content of Sb oxides is limited to 0.1% or less. The content of Sb oxides desirably falls within a range of 0 to 0.05%, preferably within a range of 0 to 0.01%, more preferably within a range of 0 to 0.001%, and ideally, no Sb oxides are incorporated at all (the glass does not contain Sb). Leaving out Sb (being Sb-free) greatly reduces the density of residual bubbles in the glass from several dozen percent to about one percent. Here, the term “Sb oxides” means oxides such as Sb₂O₃ and Sb₂O₅ that are dissolved in the glass, irrespective of the valence of Sb.

Since Sb oxides have a greater impact on the environment than Sn oxides and Ce oxides, it is also desirable to reduce the quantity of Sb oxides employed to zero from the perspective of lowering the environmental impact.

As is a powerful clarifying agent. However, it is also toxic, and is thus desirably left out. F also exhibits a clarifying effect, but volatizes during glass manufacturing. That causes the properties and characteristics of the glass to vary, creating problems in terms of stable melting and molding. Volatization also ends up generating heterogeneous portions called striae in the glass. When polishing is conducted with striae present in the glass, the glass removal speed will vary slightly between the striae portions and the homogenous portions, thereby generating uneveness in the polished surface. That is undesirable in cover glasses, which are required to be highly flat. Accordingly, As and F are desirably not incorporated into glass A.

Halogens other than F—that is, Cl, Br, and I—are desirably not added to glass A. These halogens also volatize from the glass melt, generating striae and compromising the image quality of the display.

Since Pb, Cd, and the like are substances that have a negative impact on the environment, their incorporation in glass A is also desirably avoided.

Glasses that do not contain Sb or As lend themselves well to molding by the down-draw method and float method.

Glass A is prepared by a step of melting glass starting materials, a step of clarifying the glass melt obtained by melting, a step of homogenizing the glass melt that has been clarified, and a step of causing the homogenized glass melt to flow out and molding it. Of these steps, the clarifying step is conducted at a relatively high temperature and the homogenizing step is conducted at a relatively low temperature. In the clarifying step, bubbles are positively generated in the glass, and the minute bubbles that are contained in the glass are picked up into large bubbles, tending to cause them to rise and promoting clarification. Additionally, the method of eliminating bubbles by incorporating the oxygen that is present as a gas in the glass as a glass component in a state where the temperature of the glass has been lowered for flowing out is also effective.

In glass A, Sn oxides function well to release oxygen gas at high temperatures, picking up minute bubbles that are contained in the glass into larger bubbles which then tend to rise, thereby promoting clarification. Ce oxides function well to pick up as a glass component the oxygen that is present as a gas in the glass at low temperatures, eliminating bubbles. When the size of the bubbles (the size of the bubbles (voids) remaining in the solidified glass) falls within a range of 0.3 mm or less, the Sn oxides function strongly to remove both relatively large bubbles and minute bubbles. When Ce oxides are added along with Sn oxides, the density of large bubbles of about 50 μm to 0.3 mm is reduced to about one part in several tens of parts. Having both Sn oxides and Ce oxides present in this manner enhances the glass clarifying effect over a broad temperature range from the high temperature range to the low temperature range, making it possible to achieve adequate bubble elimination even in glasses in which the incorporation of Sb oxides, As, and F has been limited.

When the combined content of Sn oxides and Ce oxides is less than 0.1%, an adequate clarifying effect cannot be expected. At greater than 3.5%, Sn oxides and Ce oxides remain unmelted, presenting the risk of forming foreign material and contaminating the glass. Even trace quantities of foreign material become light-scattering sources, ending up decreasing the image quality of the display. When preparing a crystallized glass, Sn and Ce function to produce crystal nuclei. However, glass A is an amorphous glass, so heating to precipitate crystals is undesirable. When the quantity of Sn and Ce is excessive, such precipitating of crystals tends to occur. Thus, the addition of excessive quantities of Sn oxides and Ce oxides is to be avoided. For these reasons, the combined content of Sn oxides and Ce oxides in glass A is specified as 0.1 to 3.5%. The combined content of Sn oxides and Ce oxides desirably falls within a range of 0.1 to 2.5%, preferably within a range of 0.1 to 1.5%, and more preferably, within a range of 0.5 to 1.5 percent.

In glass A, the ratio of the content of Sn oxides to the combined content of Sn oxides and Ce oxides (Sn oxide content/(Sn oxide content+Ce oxide content)) is specified as 0.01 to 0.99. This ratio desirably falls within a range of 0.02 or greater, preferably within a range of ⅓ or greater, more preferably within a range of 0.35 to 0.99, still more preferably within a range of 0.45 to 0.99, yet more preferably within a range of 0.45 to 0.98, and yet still more preferably, within a range of 0.45 to 0.85.

When this ratio is less than 0.01 or exceeds 0.99, it is difficult to achieve a synergistic effect from the clarifying effect of Sn oxides at elevated temperatures and the clarifying effect of Ce oxides at low temperatures. The lopsided addition of Sn oxides or Ce oxides causes the Sn oxides or Ce oxides that have been incorporated in large quantity to tend to remain unmelted, tending to leave unmelted material in the glass.

Sn is a substance that absorbs infrared light in glass. When employed in a cover glass, it absorbs heat rays such as the infrared component of sunlight, functioning to reduce damage to the interior of the display due to irradiation by heat rays.

When Ce is irradiated with intense ultraviolet light using an ultraviolet lamp or the like, it emits blue fluorescence. It is thus possible to irradiate Ce-containing glass A with ultraviolet light to cause it to generate fluorescence, making it possible to readily distinguish between glass A and a glass to which Ce has not been added, which would otherwise be identical in appearance and difficult to distinguish visibly. Thus, glass A, and cover glasses or glass base materials comprised of glass A, have an identification function.

Utilizing this identification function, it is possible to rapidly detect whether or not a cover glass is comprised of glass A without analyzing the composition of the glass in the process of producing cover glasses in which multiple types of glass are mixed and in the process of producing displays. It is also possible to prevent the mixing of glass A and other glasses.

Since identification of the glass is easy, when some problem occurs with a cover glass, the cause of the problem can be readily determined and a solution quickly devised.

In the course of adhering a shatter-proof film on the surface of a cover glass, and in the course of printing a product name, number, and manufacturing origin on the surface of a cover glass or on the surface of the film, ultraviolet light can be irradiated and the fluorescence emitted by Ce can be utilized to detect the edge of the cover glass. The operations of positioning the film and aligning the printing position can then be efficiently conducted.

For these reasons, in addition to the combined content of Sn oxides and Ce oxides, it is important to establish the ratio of the content of Sn oxides and Ce oxides in the manner set forth above.

The content of Sn oxides is desirably 0.1% or greater to achieve the clarifying effect and infrared light-absorbing effect set forth above. However, at greater than 3.5%, they precipitate as foreign materials in the glass, compromising the image quality of the display. Accordingly, the content of Sn oxides is desirably 0.1 to 3.5%. From the above perspectives, the Sn content preferably falls within a range of 0.1 to 2.5%, more preferably within a range of 0.1 to 1.5%, and still more preferably, within a range of 0.5 to 1.0%. Here, the term “Sn oxides” means oxides such as SnO and SnO₂ that are dissolved in the glass, irrespective of the valence of Sn. The Sn oxide content is the combined content of oxides such as SnO and SnO₂.

The content of Ce oxides is desirably 0.1% or greater to achieve the clarifying effect and ultraviolet light-absorbing effect set forth above. However, at greater than 3.5%, reactions with the refractory materials and platinum that constitute the melt vessel and reactions with the molding apparatus used to mold the glass intensify, impurities increase, the internal quality of the glass decreases, and coloration tends to increase. Further, the excessive addition of Ce oxides causes visible light, particularly light in the short wavelength range of the visible light, to be absorbed, and Ce itself tends to discolor the glass. Accordingly, the content of Ce oxides is desirably kept to 0.1 to 3.5%, preferably within a range of 0.5 to 2.5%, more preferably within a range of 0.5 to 1.5%, and still more preferably, within a range of 0.5 to 1.0%. Here, the term “Ce oxides” means oxides such as CeO₂ and Ce₂O₃ that are dissolved in the glass, irrespective of the valence of Ce. The Ce oxide content is the combined content of oxides such as CeO₂ and Ce₂O₃.

Sheet glass, which is the base material of cover glasses, can be molded by the down-draw method and the float method, for example. Glass A, which contains Sn oxides, is desirable from the perspective of stable molding of the glass into thin sheets by these methods. During sheet molding, thermal radiation is emitted by the glass melt at high temperature. However, the Sn within the glass absorbs infrared light, causing thermal radiation to be absorbed in the glass. That lowers the speed of cooling by thermal radiation and slightly reduces the speed at which the viscosity of the glass rises, which is advantageous in forming thin plates.

A cover glass comprised of glass A containing Sn oxides and Ce oxides can be mounted in a display device in which an image pickup element has been installed. The image that is picked up through the cover glass can then be rendered sharp by the infrared and ultraviolet light-cutting effects of the cover glass.

A clarifying agent in the form of 0 to 1% of a sulfate can be added to glass A. Mirabilite (Na₂SO₄), K₂SO₄, Li₂SO₄, MgSO₄, CaSO₄, and the like can be employed as the sulfate.

To further enhance the clarifying effect in glass A, it is desirable to render the viscosity at 1,400° C. 10³ dPa·s or lower, preferably 10^{2.7} dPa·s or lower.

Doing so reduces the density of residual bubbles contained per unit weight of glass to 60 pieces/kg or less, desirably 40 pieces/kg or less, more preferably 20 pieces/kg or less, still more preferably 10 pieces/kg or less, yet more preferably 2 pieces/kg or less, and yet still more preferably 0 piece/kg. Thus, glass that is suitable as a cover glass can be mass produced with high productivity.

The method of manufacturing glass A will be described next.

First, glass starting materials in the form of oxides, carbonates, nitrates, sulfates, hydroxides, and the like, as well as clarifying agents such as SnO₂ and CeO₂, are weighed out and mixed in proportions that will yield glass A. These glass starting materials are then melted to obtain a glass melt, which is clarified and molded to obtain glass A.

A desirable method of manufacturing glass A is to maintain the glass melt at 1,400 to 1,600° C., lower the temperature and maintain it at 1,200 to 1,400° C., and then mold the glass melt. Maintaining the glass melt at 1,400 to 1,600° C. lowers the viscosity of the glass to create a state where the bubbles in the glass tend to rise and in which Sn releases oxygen, promoting a clarifying effect. Subsequently lowering the temperature of the glass melt and maintaining it at 1,200 to 1,400° C. makes it possible to cause Ce to pick up oxygen, greatly enhancing the elimination of bubbles.

In the above method of manufacturing glass in which both Sn and Ce are present in the glass melt, the characteristic of the glass of having a viscosity of 5×10³ dPa·s or lower, preferably 1×10³ dPa·s or lower, at 1,400° C. and the synergistic effect achieved by the presence of both Sn and Ce markedly improve the elimination of bubbles.

Denoting the period of maintenance at 1,400 to 1,600° C. as TH and the period of maintenance at 1,200 to 1,400° C. as TL, TL/TH is desirably 0.5 or less, preferably 0.2 or less. Increasing TH relative to TL in this manner facilitates the discharging of gas within the glass to the exterior of the glass. However, from the perspective of promoting the effect of Ce picking up gas in the glass, it is desirable for TL/TH to be greater than 0.01, preferably greater than 0.02, more preferably greater than 0.03, and still more preferably, greater than 0.04.

The temperature differential when lowering the temperature from within the range of 1,400 to 1,600° C. to within the range of 1,200 to 1,400° C. is desirably 30° C. or greater, preferably 50° C. or greater, more preferably 80° C. or greater, still more preferably 100° C. or greater, and yet more preferably, 150° C. or greater from the perspective of increasing the bubble-eliminating effects of Sn and Ce. The upper limit of the temperature differential is 400° C.

In the above method of manufacturing glass, the quantities of Sn and Ce added are desirably established so that the density of residual bubbles in the glass is 60 pieces/kg or less. It is possible to utilize the characteristic of the glass of having a viscosity of 10³ dPa·s at 1,400° C. to further reduce the density of residual bubbles in the glass. The quantities of Sn and Ce added are desirably established so that the density of residual bubbles in the glass becomes 40 pieces/kg or less. The quantities of Sn and Ce added are preferably established so that it becomes 20 pieces/kg or less. The quantities of Sn and Ce added are more preferably established so that it becomes 10 pieces/kg or less. The quantities of Sn and Ce added are still more preferably established so that it becomes 2 pieces/kg or less. And the quantities of Sn and Ce added are ideally established so that the density of residual bubbles in the glass goes to 0 piece/kg. Even when residual bubbles are present, the size of the bubbles can be kept to 0.3 mm or less.

In the above glass manufacturing method, the melting tank and clarifying tank in which the glass starting materials are heated and vitrified are desirably comprised of a refractory material such as electrocast brick or burned brick, and the work tank and the pipe connecting the clarifying tank and the work tank, or the outflow pipe, are desirably made of platinum or a platinum alloy (referred to as a “platinum-based material”). The molten material in the melting tank where the starting materials are vitrified and the glass melt in the clarifying tank when the maximum temperature is reached in the glass manufacturing process both exhibit high corrosiveness. Although platinum-based materials exhibit good corrosion resistance, when they come into contact with highly corrosive glass, they are corroded by the glass and mix into the glass as solid platinum materials. Since solid platinum materials exhibit resistance to corrosion, once platinum has mixed into the glass as a solid material, it does not completely melt into the glass, but remains as an impurity in the molded glass. However, when a refractory material corrodes and mixes into the glass, it melts into the glass and tends not to remain as an impurity. Accordingly, the melting tank and clarifying tank are desirably made of refractory materials. When the work tank is made of a refractory material, the surface of the refractory material melts into the glass melt, producing striae in the glass during homogenization and ending up causing heterogeneity. The temperature of the work tank reaches 1,400° C. or lower, reducing the corrosiveness of the glass. Thus, the work tank, connecting pipe, and outflow pipe are desirably comprised of a platinum-based material that tends not to melt into the glass. The stirring apparatus that stirs and homogenizes the glass melt in the work tank is also desirable comprised of a platinum-based material.

### [Sheet Molding]

The cover glass of the present invention can be fabricated by heating and melting glass starting materials, molding into sheet form by the down-draw method, flow method, or the like to obtain a glass base material, and then processing the glass base material, for example. Melting of the glass here is as described in the method of manufacturing glass A.

In the down-flow method, a trough-shaped molded member made of a ZrO₂-based refractory material having a channel to guide the glass melt on top is employed. Glass melt is caused to overflow from both sides of the channel to divide the flow of glass. After dropping along the surface of the molded member, the glass melts flow together beneath the molded member, being pulled downward and forming a sheet. In order to prevent contraction in the direction of width of the glass during molding and to improve the flatness of the sheet glass, the glass melt flows can be joined beneath the molded member, the two sides of the glass that has assumed a sheet form can be gripped by a pair of knurl rolls in a manner that does not impede downward movement of the glass, and local cooling can be conducted.

In this method, since the surfaces that come into contact with the molded member are adhered together by confluence of the glass beneath the molded member, the marks of contact with the molded member are erased and such marks are not produced on the main surface of the sheet glass. Accordingly, glass of the required shape can be cut out of the glass base material by etching or the like as set forth further below and a cover glass can be produced without polishing the main surfaces of a glass base material that has been molded by the down-draw method. However, the main surfaces of the glass base material can be suitably polished.

In the float method, a glass melt is caused to flow out onto the molten metal of a float bath, and molded into sheet form by being pulled horizontally. In the same manner as with the down-draw method, in the float method, it is also possible for the two sides of the glass to be gripped with a pair of knurl rolls and locally cooled.

In both the down-draw method and float method, the glass that has been molded into sheet form is caused to continuously move from the molding zone to an annealing zone, and annealing is conducted. In the process from molding to cooling, the in-plane temperature distribution of the sheet-shaped glass is desirably controlled by a known method so that the flatness of the glass is not lost. From molding to annealing, the continuous, long sheet of glass is cut to prescribed length after annealing and sent to post-processing.

### [Processing Into a Cover Glass]

The sheet-shaped glass in which strains have been reduced by annealing can be cut as needed into a size that can be readily processed into a cover glass. The glass plate thus obtained is called a glass base material.

The contour shape of the cover glass does not necessarily consist of straight lines. It will often consist of complex contour lines, such as shapes containing curves. Since it has a thickness of 1.0 mm or less, there is a problem in that it tends to be damaged by the application of large forces during processing steps. To deal with this problem, the method of cutting the cover glass out of the glass base material by etching is desirable. In that method, a resist is first used to expose a portion of the glass surface corresponding to the contours of the cover glass that is to be obtained on the main surface of the glass base material by a known method, and the region that is surrounded by the contours is coated with the resist. Once a resist pattern has been formed in this manner, the pattern is employed as a mask and the glass base material is etched to cut the cover glass out of the glass base material.

Since glass A has good chemical durability, roughness due to etching on the edge surfaces of the cover glass that has been cut out can be inhibited. The surface roughness of the edge surfaces (arithmetic mean roughness Ra) can be kept to 10 nm or less. According to this method, the edge surfaces of the cover glass are extremely smooth and microcracks formed by mechanical cutting and the like are not produced. Microcracks on edge surfaces often become the starting points of fractures, so smoothing of edge portions can increase mechanical strength. The method of etching the glass base material can be either wet etching or dry etching. From the perspective of keeping down processing costs, wet etching is desirable. Any etchant capable of etching the glass substrate can be employed in wet etching. For example, acid solutions comprised chiefly of hydrofluoric acid, mixed acids of hydrofluoric acid and at least one acid from among sulfuric acid, nitric acid, hydrochloric acid, and hydrofluosilicic acid, can be employed. Any etchant capable of etching the glass substrate can be employed in dry etching. Examples are fluorine-based gases.

The cover glass can be processed by know laser cutting and mechanical processing. In mechanical processing, glass that has been cut to a prescribed shape by water jet, sand blast, laser, or mechanical scrib is ground with a diamond-electrodeposited grindstone of about #400 to 800, for example, to achieve a desired shape. Countless microcracks will remain on the processed surface of glass that has been subjected to laser or mechanical processing. Such a glass substrate can be wet etched as set forth above to remove the microcracks, thereby achieving mechanical strength identical to that of an etched substrate.

The thickness of the cover glass of the present invention is 1.0 mm or less, desirably 0.8 mm or less, and preferably, 0.5 mm or less. The lower limit of the cover glass of the present invention can be suitably set taking into account the application and the mechanical strength of the cover glass of the present invention. For example, it can be 0.1 mm or more, desirably 0.2 mm or more, preferably 0.25 mm or more, and more preferably, 0.3 mm or more.

### [Chemical Reinforcement]

Glass A is suitable as a chemically reinforced glass. Glass A can be chemically reinforced, for example, by immersing a piece of glass A that has been processed into a cover glass of desired shape in a molten alkali salt. The molten salt employed can be molten sodium nitrate, molten potassium nitrate, or a mixed molten salt of the two. Glass A contains at least either Li₂O or Na₂O as a glass component. When glass A contains Li₂O as a component, it is chemically reinforced using a molten sodium salt, or a molten sodium salt and a molten potassium salt. When glass A does not contain Li₂O, that is, when it contains just Na₂O from among L1₂0 and Na₂O, a molten potassium salt can be employed in chemical reinforcement.

Chemical reinforcement processing refers to bringing the surface of the glass into contact with a chemical reinforcement processing solution (molten salt) to cause some of the ions contained in the glass to be replaced with larger ions that are contained in the chemical reinforcement processing solution, thereby chemically reinforcing the glass substrate. When the glass is immersed in a molten salt, Li ions in the vicinity of the surface of the glass undergo ion exchange with the Na ions and K ions in the molten salt, and Na ions in the vicinity of the surface of the glass undergo ion exchange with K ions in the molten salt, forming a compressive stress layer on the glass surface. The temperature of the molten salt during chemical reinforcement is a temperature that is higher than the strain point of the glass and lower than the glass transition point, desirably falling within a temperature range in which the molten salt does not thermally decompose. Since the molten salt is employed repeatedly, the concentration of the various alkali ions in the molten salt gradually changes and glass components other than Li and Na leach out in minute quantities. As a result, the processing conditions set forth above move out of the optimal range. Such variation in chemical reinforcement due to changes over time in the molten salt can be reduced by adjusting the composition of glass A as set forth above. Setting a high concentration of K ions in the molten salt also reduces this variation. The fact that chemical reinforcement processing has been conducted can be confirmed by the method of observing a cross-section of the glass (along a plane cutting the processed layer) by the Babinet method, by the method of measuring the distribution of alkali ions (such as Li⁺, Na⁺, and K⁺) in the direction of depth from the glass surface (the Senarmont method), or the like.

The cover glass of the present invention is 1.0 mm or less, desirably 0.8 mm or less, and preferably, 0.5 mm or less in thickness. As such, it is extremely thin. However, since the level of residual bubbles from the glass melt is kept extremely low, the compressive stress layer that is formed by chemical reinforcement need only be 5 μm or greater. The thickness of the compressive stress layer desirably falls within a range of 50 μm or greater, preferably within a range of 100 μm or greater. The upper limit of thickness of the compressive stress layer can be determined with the plate thickness in mind. The compressive stress layer of the cover glass will be of identical thickness on front and back. When no tensile stress layer is present between the compressive stress layers, no chemical reinforcement is achieved. Thus, the upper limit of the thickness of the compressive stress layer can be determined with the plate thickness in mind. In the portable electronic devices of recent years, the number of products that are operated by having a touch pen or the like directly contact the cover glass has been increasing, and high mechanical strength (scratch resistance, fracturing strength, rigidity, and the like) is being demanded of cover glasses. The compressive stress is desirably 300 MPa or greater, preferably 600 MPa or greater, and more preferably, 800 MPa or greater. Compressive strength with such a high value can be formed by adjusting conditions such as the chemical reinforcement period and the composition, density, and temperature of the alkali molten salt.

### (Identification Function Based on Fluorescence)

As set forth above, the cover glass of the present invention contains Ce, and thus generates blue fluorescence when irradiated with intense ultraviolet light using a UV lamp or the like. Utilizing this phenomenon, it is possible to readily distinguish between a cover glass or a glass base material comprised of glass A and a cover glass or a glass base material comprised of a glass to which Ce has not been added, which are identical in external appearance and are difficult to distinguish visually. That is, by irradiating ultraviolet light and determining whether or not fluorescence is produced, it is possible to determine whether or not a cover glass or a glass base material is comprised of glass A without having to analyze the glass composition. To facilitate the determination of whether or not fluorescence has been produced, this inspection is desirably conducted in a dark room. A commercially available UV lamp can be employed.

When employing multiple types of glass, it is possible to avoid the problem of mixing in heterogenous glass by conducting an inspection based on irradiation with ultraviolet light as set forth above. When a problem occurs with a specific type of cover glass in the course of manufacturing displays using multiple types of cover glasses, the manufacturing origin of the cover glass can be readily specified based on the presence or absence of fluorescence. Thus, the cause of the problem and a solution to it can be readily determined. It also serves as a function for identifying other products.

When intense ultraviolet light is irradiated and the surface of the glass is observed in a dark room, it is also possible to readily detect the presence or absence of foreign material on the surface of the glass with the fluorescence emitted by Ce.

[Cover Glass with Shatter-Proof Film]

One aspect of the cover glass of the present invention is a cover glass the surface of which is equipped with a shatter-proof film. As cover glasses have become ultrathin, it has become difficult to identify the edge position of the cover glass. For example, in the course of adhering a shatter-proof film to the surface of a cover glass, the film is aligned with the edge of the glass and adhered. When conducting such an operation, ultraviolet light can be irradiated onto the glass to cause the Ce to generate fluorescence, thereby causing the contours of the cover glass to stand out and facilitating alignment.

In the course of printing the product name, product number, or manufacturing origin on the surface of a cover glass or on the surface of a shatter-proof film, ultraviolet light can be irradiated and the fluorescence emitted by Ce can be used to readily detect the edge of the cover glass and more efficiently conduct the operation of aligning the print position.

### [Display]

The display of the present invention is one that is obtained by preparing the cover glass of the present invention as set forth above and installing the cover glass of the present invention so that it covers the display surface.

A desirable embodiment of the display of the present invention is a display with good portability or that is employed outdoors, such as a portable information terminal, portable telephone, or car navigation device.

Since the cover glass that is installed in the present invention is 1.0 mm or less, desirably 0.8 mm or less, and preferably, 0.5 mm or less in thickness, which is thin, and it affords good mechanical strength, it is suited to the above displays in which size reduction is required and that are employed in harsh environments.

In particular, in portable information terminals and portable telephones, the surface of the cover glass tends to scratch during handling. In touch panel-type displays, the surface of the cover glass is pressed, stroked, or the like with each operation. In folding and opening/closing type devices, such as some portable telephones, a shock and an external force are applied each time the device is folded or opened/closed. In other forms, when being carried, the device is transported with the cover glass exposed, imparting a powerful shock to the cover glass, and the surface of the cover glass is subjected to loads such as friction. Even in such applications, as well, the display of the present invention exhibits good durability.

Chemical reinforcement of the cover glass of the present invention also increases anti-bending strength, further enhancing fracturing resistance.

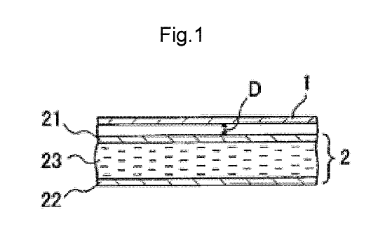

FIG. 1 is a partial sectional view of a portable display on which the cover glass of the present invention has been installed. In the display shown in FIG. 1, a cover glass 1 is disposed at a prescribed distance D above a liquid-crystal display panel 2. Liquid-crystal display panel 2 is comprised of a liquid-crystal layer 23 sandwiched between a pair of glass substrates 21, 22. In FIG. 1, the other members that are commonly employed in liquid-crystal display panels, such as a backlighting source, have been omitted. The light source employed can be a combination of white LED, near infrared LED, and a phosphor, an EL element, or the like.

The cover glass of the present invention has the function of cutting ultraviolet light and infrared light because it contains Sn oxides, which absorb infrared light, and Ce oxides, which absorb ultraviolet light. Thus, even when the display screen is exposed to light containing ultraviolet light and infrared light, such as sunlight, the cover glass absorbs the ultraviolet light and infrared light, making it possible to reduce the wear and tear on the interior of the display caused by ultraviolet light and infrared light.

In one embodiment of the display of the present invention that is equipped with an image display element and an image pickup element, such as a portable telephone with a camera, the image display element and image pickup lens are covered by a cover glass. Thinning of the cover glass prevents deterioration of the quality of the image that is picked up and the cover glass functions as an ultraviolet light and infrared light-absorbing filter, making it possible to pick up sharp images.

### Embodiments

The present invention will be described in greater detail below through embodiments. However, the present invention is not limited to the forms shown in the embodiments.

### (1) Melting the Glass

Starting materials such as oxides, carbonates, nitrates, and hydroxides, and clarifying agents such as SnO₂ and CeO₂, were weighed out and mixed in proportions calculated to yield glasses of the various compositions of basic compositions 1 to 8 in Table 1 to which were added, based on the total amount of the glass components, the quantities of SnO₂ and CeO₂ indicated by Nos. 1 to 36 in Table 2, to obtain blended starting materials for obtaining 288 types of glasses. Each of the starting materials was charged to a melt vessel, heated to within a range of 1,400 to 1,600° C. for six hours and melted, clarified and stirred to prepare a homogenous glass melt free of bubble and unmelted material. A homogenous glass melt free unmelted material was prepared. After have been maintained for six hours within a range of 1,400 to 1,600° C., the temperature of the glass melt was lowered (temperature lowering) and maintained for one hour within a range of 1,200 to 1,400° C. to markedly enhance the clarifying effect. In particular, the fact that the clarifying effect was highly marked in glass melts in which Sn and Ce were both present was determined as set forth above. The glass compositions given in Tables 1 and 2 are based on compositions in which oxides are expressed as mol % (with clarifying agents such as SnO₂ and CeO₂ being indicated as added mass % based on the total amount of the glass components).

TABLE 1

| | Glass composition (mol %) | | | |
|---|---|---|---|---|
| | Basic | Basic | Basic | Basic |
| | composi- | composi- | composi- | composi- |
| | tion 1 | tion 2 | tion 3 | tion 4 |
| SiO₂ | 65.0 | 67.0 | 69.0 | 65.0 |
| Al₂O₃ | 9.0 | 9.0 | 7.0 | 9.0 |
| SiO₂ + Al₂O₃ | 74.0 | 76.0 | 76.0 | 74.0 |
| B₂O₃ | 0.0 | 0.0 | 0.0 | 1.5 |
| Li₂O | 13.0 | 8.0 | 8.0 | 11.0 |
| Na₂O | 10.0 | 11.0 | 11.4 | 2.0 |
| Li₂O + Na₂O | 23.0 | 19.0 | 19.4 | 13.0 |
| K₂O | 0.0 | 0.5 | 0.1 | 1.0 |
| Li₂O + Na₂O + K₂O | 23.0 | 19.5 | 19.5 | 14.0 |
| MgO | 0.0 | 1.5 | 1.0 | 6.0 |
| CaO | 0.0 | 2.0 | 2.0 | 0.0 |
| SrO | 0.0 | 0.0 | 0.5 | 0.0 |
| BaO | 0.0 | 0.0 | 0.0 | 0.0 |
| ZnO | 0.0 | 0.0 | 0.0 | 2.5 |
| MgO + CaO + SrO + | 0.0 | 3.5 | 3.5 | 8.5 |
| BaO + ZnO | | | | |
| MgO + CaO | 0.0 | 3.5 | 3.0 | 6.0 |
| ZrO₂ | 3.0 | 1.0 | 1.0 | 1.0 |
| TiO₂ | 0.0 | 0.0 | 0.0 | 1.0 |
| ZrO₂ + TiO₂ | 3.0 | 1.0 | 1.0 | 2.0 |
| Total | 100.0 | 100.0 | 100.0 | 100.0 |
| Viscosity at 1400° C. | 200 | 300 | 350 | 320 |
| (dPa · s) | | | | |
| | Glass composition (mol %) | | | |
| | Basic | Basic | Basic | Basic |
| | composi- | composi- | composi- | composi- |
| | tion 5 | tion 6 | tion 7 | tion 8 |
| SiO₂ | 67.0 | 71.0 | 66.0 | 64.0 |
| Al₂O₃ | 11.0 | 1.0 | 9.0 | 8.0 |
| SiO₂ + Al₂O₃ | 78.0 | 72.0 | 75.0 | 72.0 |
| B₂O₃ | 0.0 | 0.0 | 0.0 | 0.0 |
| Li₂O | 0.0 | 0.0 | 0.0 | 0.0 |
| Na₂O | 12.0 | 15.0 | 6.0 | 16.0 |
| Li₂O + Na₂O | 12.0 | 15.0 | 6.0 | 16.0 |
| K₂O | 4.0 | 0.0 | 4.0 | 4.0 |
| Li₂O + Na₂O + K₂O | 16.0 | 15.0 | 10.0 | 20.0 |
| MgO | 2.5 | 6.0 | 2.0 | 3.0 |
| CaO | 2.5 | 7.0 | 2.0 | 3.0 |
| SrO | 0.0 | 0.0 | 0.0 | 0.0 |
| BaO | 0.0 | 0.0 | 0.0 | 0.0 |
| ZnO | 0.0 | 0.0 | 5.0 | 0.0 |
| MgO + CaO + SrO + | 5.0 | 13.0 | 9.0 | 6.0 |
| BaO + ZnO | | | | |
| MgO + CaO | 5.0 | 13.0 | 4.0 | 6.0 |
| ZrO₂ | 0.0 | 0.0 | 3.0 | 2.0 |
| TiO₂ | 1.0 | 0.0 | 3.0 | 0.0 |
| ZrO₂ + TiO₂ | 1.0 | 0.0 | 6.0 | 2.0 |
| Total | 100.0 | 100.0 | 100.0 | 100.0 |
| Viscosity at 1400° C. | 1000 | 1000 | 1000 | 1000 |
| (dPa · s) | | | | |

TABLE 2

| | Added amount based on the total | | | | | | |
|---|---|---|---|---|---|---|---|
| | amount of the glass components | | | | | | |
| | (mass %) | | | | SnO₂/ | | |
| | | | | SnO₂ + | (SnO₂ + | Bubble | Unmelted |
| No. | SnO₂ | CeO₂ | Sb₂O₃ | CeO₂ | CeO₂) | rank | rank |
| 1 | 0.01 | 0.09 | 0.00 | 0.10 | 0.10 | E | S |
| 2 | 0.2 | 0.1 | 0.00 | 0.30 | 0.67 | B | S |
| 3 | 0.3 | 0.5 | 0.00 | 0.80 | 0.38 | C | S |
| 4 | 0.5 | 0.3 | 0.00 | 0.80 | 0.63 | S | S |
| 5 | 0.7 | 0.1 | 0.00 | 0.80 | 0.88 | A | S |
| 6 | 0.6 | 0.4 | 0.00 | 1.00 | 0.60 | S | S |
| 7 | 0.75 | 0.75 | 0.00 | 1.50 | 0.50 | S | S |
| 8 | 1 | 0.7 | 0.00 | 1.70 | 0.59 | S | B |
| 9 | 0.05 | 1.95 | 0.00 | 2.00 | 0.03 | D | B |
| 10 | 1.5 | 0.5 | 0.00 | 2.00 | 0.75 | S | B |
| 11 | 1.2 | 1.1 | 0.00 | 2.30 | 0.52 | S | B |
| 12 | 0.1 | 2.4 | 0.00 | 2.50 | 0.04 | D | B |
| 13 | 1.2 | 1.3 | 0.00 | 2.50 | 0.48 | S | B |
| 14 | 2 | 0.5 | 0.00 | 2.50 | 0.80 | S | B |
| 15 | 2.45 | 0.05 | 0.00 | 2.50 | 0.98 | B | B |
| 16 | 0.1 | 2.6 | 0.00 | 2.70 | 0.04 | D | C |
| 17 | 0.5 | 2.2 | 0.00 | 2.70 | 0.19 | C | C |
| 18 | 1 | 1.7 | 0.00 | 2.70 | 0.37 | B | C |
| 19 | 1.5 | 1.2 | 0.00 | 2.70 | 0.56 | S | C |
| 20 | 2.5 | 0.2 | 0.00 | 2.70 | 0.93 | A | C |
| 21 | 0.2 | 2.8 | 0.00 | 3.00 | 0.07 | D | C |
| 22 | 1 | 2 | 0.00 | 3.00 | 0.33 | C | C |
| 23 | 2 | 1 | 0.00 | 3.00 | 0.67 | S | C |
| 24 | 2.7 | 0.3 | 0.00 | 3.00 | 0.90 | A | C |
| 25 | 0.1 | 3.1 | 0.00 | 3.20 | 0.03 | D | C |
| 26 | 0.5 | 2.7 | 0.00 | 3.20 | 0.16 | C | C |
| 27 | 1.2 | 2 | 0.00 | 3.20 | 0.38 | B | C |
| 28 | 1.5 | 1.7 | 0.00 | 3.20 | 0.47 | S | C |
| 29 | 2.1 | 1.1 | 0.00 | 3.20 | 0.66 | S | C |
| 30 | 3 | 0.2 | 0.00 | 3.20 | 0.94 | A | C |
| 31 | 0.1 | 3.4 | 0.00 | 3.50 | 0.03 | D | C |
| 32 | 0.8 | 2.7 | 0.00 | 3.50 | 0.23 | C | C |
| 33 | 1.4 | 2.1 | 0.00 | 3.50 | 0.40 | B | C |
| 34 | 2.3 | 1.2 | 0.00 | 3.50 | 0.66 | S | C |
| 35 | 3.2 | 0.3 | 0.00 | 3.50 | 0.91 | A | C |
| 36 | 3.46 | 0.04 | 0.00 | 3.50 | 0.99 | B | C |
| Com- | 2.16 | 2.75 | 0 | 4.91 | 0.44 | C | D |
| Ex 1 | | | | | | | |
| Com- | 2.21 | 2.8 | 0 | 5.01 | 0.44 | C | D |
| Ex 2 | | | | | | | |
| Com- | 2.4 | 2.9 | 0 | 5.3 | 0.45 | B | D |
| Ex 3 | | | | | | | |
| Com- | 2.39 | 3.05 | 0 | 5.44 | 0.44 | C | D |
| Ex 4 | | | | | | | |
| Com- | 3.52 | 8.56 | 0 | 12.08 | 0.29 | E | D |
| Ex 5 | | | | | | | |
| Com- | 0 | 0 | 0.50 | 0.00 | — | G | S |
| Ex 6 | | | | | | | |
| Com- | 0.25 | 0 | 0.15 | 0.25 | 1.00 | G | S |
| Ex 7 | | | | | | | |
| Com- | 1 | 0 | 0 | 1 | 1.00 | G | S |
| Ex 8 | | | | | | | |
| Com- | 0 | 1 | 0 | 1 | 0.00 | G | S |
| Ex 9 | | | | | | | |

Com-Ex: Comparative Example

The surface of each of the 288 types of glasses that were obtained was polished flat and smooth. From the polished surface, the interior of the glass was enlarged and observed by optical microscopy (40 to 100-fold), and the number of residual bubbles was counted. The number of residual bubbles counted was divided by the mass of the glass corresponding to the area that had been enlarged and observed to obtain the density of residual bubbles.

Glasses with 0 to 2 residual bubbles per kilogram were ranked A, those with 3 to 10 residual bubbles per kilogram were ranked B, those with 11 to 20 residual bubbles per kilogram were ranked C, those with 21 to 40 residual bubbles per kilogram were ranked D, those with 41 to 60 residual bubbles per kilogram were ranked E, those with 61 to 100 residual bubbles per kilogram were ranked F, and those with 101 or more residual bubbles per kilogram were ranked G. Table 2 gives the ranking corresponding to basic composition 1 as a typical example of the various glasses. Even with differences in composition, nearly the same effect was achieved when the quantities of SnO₂ and CeO₂ added based on the total amount of the glass components were identical.

The residual bubbles of the various above glasses were all 0.3 mm or smaller in size.

No crystals or residual unmelted starting materials were observed in the glasses thus obtained.

Next, the quantities of SnO₂ and CeO₂ indicated in Comparative Examples 1 to 9 in Table 2 were added to basic compositions 1 to 8. The glasses were melted and molded, and a check was made for residual bubbles and residual unmelted material in the glass. The results are given in Table 2. When the quantities of SnO₂ and CeO₂ were not within the proper ranges, the quality of the glass was found to decrease, such as by marked retention of bubbles and residual unmelted material in the glass.

Based on the above results, the quantities of Sn and Ce were correlated with the density of residual bubbles, the quantities of Sn and Ce added were adjusted so that the density of residual bubbles assumed a desired value or lower, and glasses were produced. That makes possible to keep the density of residual bubbles to a desired level.

Next, glasses were prepared by the same method as that set forth above, with the exception that molding was conducted with glass melts that had been maintained for 15 hours at temperatures of 1,400 to 1,600° C. and then maintained for 1 to 2 hours at temperatures of 1,200 to 1,400° C. When the residual bubble density and size, presence of crystals, and residual unmelted starting materials were checked, results identical to the above results were obtained. Denoting the period of maintenance at 1,400 to 1,600° C. as TH and the period of maintenance at 1,200 to 1,400° C. as TL, TL/TH was desirably kept to 0.5 or lower, and preferably kept to 0.2 or lower, in all of the above methods. Lengthening TH relative to TL in this manner tended to discharge the gas present in the glass outside the glass. However, in order to promote the gas uptake effect in the glass by Ce, it was desirable for TL/TH to be made greater than 0.01, preferably greater than 0.02, more preferably greater than 0.03, and still more preferably, greater than 0.04.

From the perspective of enhancing each of the bubble-eliminating effects of Sn and Ce, the temperature differential in the course of lowering the temperature from the range of 1,400 to 1,600° C. to the range of 1,200 to 1,400° C. was desirably 30° C. or greater, preferably 50° C. or greater, more preferably 80° C. or greater, still more preferably 100° C. or greater, and yet more preferably, 150° C. or greater. The upper limit of the temperature differential was 400° C.

The viscosity of the various glasses of basic compositions 1 to 8 at 1,400° C. was measured by the viscosity measuring method of JIS Standard 28803 with a coaxial double-cylindrical rotational viscometer. The measurement results are given in Table 1. The viscosity of the glass at 1,400° C. changed little with the addition of SnO₂ and CeO₂ in the ranges indicated in Table 2.

As the quantity of Ce added was increased, absorption of the glass in the short wavelength region tended to increase. In addition to this tendency, the fluorescent intensity when the glass was irradiated with ultraviolet light also increased. The addition of a quantity of Ce adequate to generate fluorescence of adequate intensity to distinguish between and identify glasses, as well as to inspect the surface of the glass for presence of foreign matter based on the fluorescence generated by the irradiation of ultraviolet light, was desirable.

From the perspective of facilitating distinguishing and inspecting with the above fluorescent light, the quantity of CeO₂ added was desirably 0.1 weight percent or greater, preferably 0.2 weight percent or greater, and more preferably, 0.3 weight percent or greater. When the quantity of CeO₂ added was outside this range, adequate fluorescent intensity was not achieved for the use of fluorescence to distinguish and inspect and it became difficult to distinguish and detect.

### (2) Molding the Glass

Next, the various above glasses were molded into sheet form using the overflow down-draw method or the float method. In both of these methods, the glass was annealed to remove strain after molding, yielding a glass base material in the form of a flat sheet of uniform thickness (0.5 mm). The surface roughness (arithmetic mean roughness Ra) of the main surface of the glass base material molded by the down-draw method as examined by atomic force microscopy was 0.2 nm. It was thus extremely smooth. Nor were any defects that could serve as the starting points of fractures such as microcracks observed.

Similarly, even thinner sheet materials of 0.45 mm, 0.40 mm, and the like were molded and glass base materials were obtained.

### (3) Processing the Glass Base Material

The two main surfaces of the glass base material were then coated with a negative hydrofluoric acid-resistant resist to a thickness of 30 μm. The hydrofluoric acid-resistant resist was then baked for 30 minutes at 150° C. Next, the resist was exposed from both surfaces through photomasks having patterns corresponding to the contour shape of a cover glass subsequently, the resist was developed with a developing solution (Na₂CO₃ solution) and a resist pattern was formed with resist remaining in regions other than regions of the glass base material to be etched.

Next, a mixed acid aqueous solution of hydrofluoric acid and hydrochloric acid was employed as etchant to etch the regions of the glass base material to be etched from the two main surface sides using the resist pattern as a mask, cutting out the cover glass. Subsequently, NaOH was used to cause the hydrofluoric acid-resistant resist remaining on the glass to swell and then separate, and rinsing was conducted.

The surface roughness (arithmetic average roughness Ra) of the main surfaces of the cover glass obtained was measured by atomic force microscopy as 0.2 nm. A high degree of smoothness was present that was identical to the surface state immediately after formation by the down-draw method. The surface roughness (arithmetic mean roughness Ra) of the edge surfaces of the cover glass was measured by atomic force microscopy as 1.2 to 1.3 nm over the entire outer shape. Thus, processing by etching made it possible to obtain low surface roughness on edge surfaces.

Scanning electron microscopy was used to determine whether or not microcracks were present on the edge surfaces of the cover glass. No microcracks were found.

### (4) Chemical Reinforcement

One hundred and forty-four types of cover glasses obtained by adding the quantities of Sn and Ce of Nos. 1 to 36 in Table 2 to basic compositions 1 to 4 of the above cover glasses were immersed for 4 hours in a processing bath of mixed molten salts comprised of 60% potassium nitrate (KNO₃) and 40% sodium nitrate (NaNO₃) maintained at 385 to 405° C. to be ion-exchange processed and chemically reinforced. The depth (thickness) of the compressive stress layers formed on the surfaces of the cover glasses measured by the Babinet method was mostly at about 150 μm. The compressive stress was 350 MPa.

Similarly, cover glasses obtained by adding Sn and Ce to basic compositions 5 to 8 were immersed in a processing bath of potassium nitrate (KNO₃) and ion-exchange processed to chemically reinforce them. The fact that compressive stress layers had been formed on the surfaces of the cover glasses in the same manner as on the above glasses was confirmed.

The surface roughness of the main surfaces and end surfaces of the cover glasses after chemical reinforcement were measured at 0.3 nm and 1.4 to 1.5 nm, respectively. No microcracks were found on the edge surfaces.

### (5) Mechanical Strength Evaluation Test of the Cover Glasses

A cover glass was set on a support base that contacted 3 mm of the outer circumference portion of the main surface of the cover glass. From the main surface on the opposite side from the side in contact with the support base, the center portion of the cover glass was pressed with a pressing member to test the static pressure strength. The pressing member employed had a tip comprised of stainless steel alloy 5 mm in diameter.

As a result, each of the above cover glasses exhibited a load at fracturing point in excess of 50 kgf, indicating extremely high mechanical strength.

### (6) Printing on a Glass Substrate

Before printing the surfaces of the various cover glasses that had been chemically reinforced as set forth above, an ultraviolet lamp was used to irradiate with ultraviolet light the surface of each cover glass in a dark room and the glass surface giving off fluorescence was observed to see whether or not foreign matter has adhered to it. After determining whether the surface was clean based on this inspection, printing was conducted by forming an ink layer on the surface of the cover glass.

In common printing on a cover glass, at least one layer and as many as 10 layers of ink are coated on each other. The front surface is not printed, so it is essential that no foreign matter, including ink, adhere to the portion of the display that transmits light. A thermosetting ink is generally employed for printing. Prior to drying, the ink can be readily removed. After a drying step by heating, called baking, it is difficult to remove the ink layer.

When coating multiple layers of ink, the drying step is conducted after the formation of the first layer of ink, after which the second layer of ink is formed, with this operation being similarly repeated thereafter to form multiple layers of ink. In this process, fluorescence can be used to readily determine whether or not ink has adhered in unwanted spots on the glass surface, or whether ink that has adhered has been completely removed, making it possible to greatly enhance the yield in print operations.

### (7) Adhering a Shatter-Proof Film

Before adhering a shatter-proof film to the surface of each of the above chemically reinforced cover glasses, an ultraviolet lamp was used to irradiate the cover glass with ultraviolet light in a dark room and the glass surface giving off fluorescence was observed to see whether or not foreign matter had adhered to it. After determining whether the surface was clean based on this inspection, a shatter-proof film was adhered to the surface of the cover glass.

First, ultraviolet light emitted by the ultraviolet lamp was irradiated onto the cover glass and the blue fluorescence emitted by the cover glass was observed. When illumination in the visible range was reduced, it was possible to determine the contours of the cover glass from the contrast between the cover glass emitting blue fluorescence and the background. In this state, the shatter-proof film was aligned with the cover glass and adhered to the surface thereof. This operation permitted the relatively easy adhesion of a shatter-proof film to an extremely thin cover glass of 0.5 mm or less in thickness. The shatter-proof film was transparent and transmitted the image indicated by the display.
(8) Various class covers fabricated in this manner were installed as covers on the display panels of portable information terminals (PDAs) to prepare portable information terminals. FIG. 1 shows a schematic cross-section of a portion of the display panel of a portable information terminal. Cover glass 1 was installed so as to cover the entire surface of a panel at a spacing D from a liquid-crystal display panel having two glass substrates disposed so as to sandwich the liquid-crystal panel and a liquid-crystal layer 3. The cover glass could also have been positioned so as to cover an image pickup lens, not shown in FIG. 1. In such a device, sharp image pickup was achieved as the cover glass cut ultraviolet and infrared light.

Similarly, various cover glasses were used to fabricate portable telephones and car navigation devices.

Each of the above devices afforded good strength and durability while being compact. The display image of the display was confirmed to cause no distortion and yield high image quality.

### INDUSTRIAL APPLICABILITY

The present invention provides a cover glass that is installed in portable telephones, personal digital assistants (PDAs), and other portable terminal devices and portable equipment, and protects display screens.

### KEY TO THE NUMBERS

1 Cover glass
2 Liquid-crystal display panel
21, 22 Glass substrates
23 Liquid-crystal layer

1. A cover glass for use in transmitting the image displayed by an image display member while covering the image display member of a display, characterized:
by being comprised of a glass comprising, converted based on the oxide and denoted as mol %:
60 to 75% of SiO₂;
0 to 12% of Al₂O₃
(where the combined content of SiO₂ and Al₂O₃ is 68% or greater);
0 to 10% of B₂O₃;
5 to 26% of Li₂O and Na₂O in total;
0 to 8% of K₂O
(where the combined content of Li₂O, Na₂O, and K₂O is 26% or less);
0 to 18% of MgO, CaO, SrO, BaO, and ZnO in total;
0 to 5% of ZrO₂, TiO₂, and HfO₂ in total;
0.1 to 3.5 weight percent of Sn oxides and Ce oxides based on the total amount of the glass components; and
a ratio of the content of Sn oxides to the combined content of Sn oxides and Ce oxides (content of Sn oxides/(content of Sn oxides+content of Ce oxides)) of 0.01 to 0.99;
the content of Sb oxides is 0.1% or less; and
by having a thickness of 1.0 mm or less.

2. The cover glass according to claim 1, wherein the cover glass has a compressive stress layer on the outer surface thereof.

3. The cover glass according to claim 2, wherein the compressive stress layer is formed by chemical reinforcement.

4. The cover glass according to claim 1, the outer surface of which is equipped with a shatter-proof film; and

5. A display, equipped with the cover glass according to claim 1 and wherein the cover glass is mounted so as to cover the display screen.
